(19) United States
(12) Patent Application Publication
(10) Pub. No.: US 2025/0004480 A1
(43) Pub. Date: Jan. 2, 2025

(54) METHOD AND SYSTEM FOR MONITORING INDUSTRIAL SAFETY, AND SELF-PROPELLED DEVICE

(71) Applicant: ALL RING TECH CO., LTD., KAOHSIUNG CITY (TW)

(72) Inventor: Chih-Chun CHEN, KAOHSIUNG CITY (TW)

(21) Appl. No.: 18/732,639

(22) Filed: Jun. 4, 2024

(30) Foreign Application Priority Data
Jun. 30, 2023 (TW) 112124662

(51) Int. Cl. G05D 1/689; G05D 1/646; G05D 105/80; G05D 107/70; G06V 20/52; G08B 21/02

(52) U.S. Cl. CPC G05D 1/689; G05D 1/646; G06V 20/52; G08B 21/02; G05D 2105/80; G05D 2107/70

(57) ABSTRACT

Method for monitoring industrial safety, which includes: setting a field feature related to a working event and an industrial safety feature related to an industrial safety event. Controlling a self-propelled device to move within a working environment while also controlling an image capturing unit to capture an environmental image of the working environment, and controlling an internal computer to analyze the environmental image. Controlling the self-propelled device to stay at a location where the field feature is captured when the environmental image is analyzed and it was determined that the field feature exists in the working environment; and controlling the self-propelled device to transmit an industrial safety information related to the industrial safety event to the terminal device when the analysis of the captured environmental image indicates that the industrial safety feature exists in the field feature, thereby helping the industrial safety personnel to realize the on-site situation remotely.

### CROSS-REFERENCE TO RELATED APPLICATION

This application claims priority to Taiwan Application Serial Number 112124662, filed Jun. 30, 2023, which is herein incorporated by reference in its entirety.

### BACKGROUND

### Field of Invention

The invention relates to a method and a system for monitoring industrial safety, and a self-propelled device. More particularly, the invention relates to a method and a system for monitoring industrial safety, and a self-propelled device that can automatically move to the work site to monitor industrial safety.

### Description of Related Art

In order to ensure the safety of workers in the working environment, many companies have formulated a standard operating procedure (SOP) to prevent the occurrence of industrial safety-related accidents. However, workers may simplify their own operating procedure for convenience during work, so companies that pay more attention to work safety will hire work safety personnel to monitor whether there may be any incidents inconsistent with work safety occurring at the work site. The said incidents may include: personnel not wearing protective clothing, safety helmets, and/or goggles, personnel not operating tools properly, debris scattered on site, personnel fell down, people gathered in groups, and/or people being stranded, etc.

However, because industrial safety personnel need to personally monitor workers at the work site, when there are multiple work sites in the work environment, the industrial safety personnel will be required to travel among multiple work sites, which becomes labor-intensive. Moreover, at many work sites, it is inconvenient to communicate with the outside world. When a major industrial safety event occurs, the industrial safety personnel at the work site cannot timely contact the outside world and cannot receive immediate assistance. In addition, when an industrial safety event such as a poisonous gas leak occurs, the industrial safety personnel may also be trapped and therefore would be unable to seek help from the outside world.

### SUMMARY

Therefore, a purpose of the invention is to provide a method for monitoring industrial safety that can overcome at least one disadvantage of the prior art.

Another purpose of the invention is to provide a system for monitoring industrial safety that can be used to implement the method for monitoring industrial safety.

Another purpose of the invention is to provide a self-propelled device that can be used to implement the method for monitoring industrial safety.

According to the purpose of the invention, the method for monitoring industrial safety includes: providing a self-propelled device having an image capturing unit and an internal computer; providing a terminal device having a display device and configured to receive industrial safety information related to the industrial safety event from the self-propelled device; setting a field feature related to a working event and an industrial safety feature related to an industrial safety event; controlling the self-propelled device to move within a working environment while also controlling the image capturing unit to capture an environmental image of the working environment, and further controlling the internal computer to analyze the captured environmental image; controlling the self-propelled device to stay at a location when the analyzed environmental image indicates presence of the field feature at the working environment; controlling the image capturing unit to continue to capture additional environmental images with the field feature and controlling the internal computer to continue to analyze the environmental images during the time self-propelled device stays at the working environment; and controlling the self-propelled device to transmit an industrial safety information related to the industrial safety event to the terminal device and display the industrial safety information on the display device, when the analysis of the captured environmental image indicates presence of the industrial safety feature in the field feature.

According to another purpose of the invention, the system for monitoring industrial safety is used to implement the method for monitoring industrial safety.

According to another purpose of the invention, the self-propelled device is used to implement the method for monitoring industrial safety.

According to the method and the system for monitoring industrial safety, and the self-propelled device in accordance with the embodiments of the invention, the self-propelled device can capture an environmental image of the working environment and analyze the environmental image. When the working event occurs, the self-propelled device is controlled to stay at a location that the working event occurs and is controlled to monitor whether the industrial safety event occurs. When the industrial safety event occurs, the self-propelled device transmits the industrial safety information related to the industrial safety event to the terminal device, so that the industrial safety personnel at a remote location can be timely informed of the on-site situation.

### BRIEF DESCRIPTION OF THE DRAWINGS

FIG. 1 is a diagram of a self-propelled device on a walking surface to illustrate an embodiment of the invention.

FIG. 2 is a diagram of the self-propelled device in a working environment.

FIG. 3 is a diagram of map information obtained by the self-propelled device.

FIG. 4 is a diagram of a system for monitoring industrial safety, including the self-propelled device, an external computer and a terminal device.

FIG. 5 is a diagram of the external computer.

FIG. 6 is a diagram of the terminal device.

FIG. 7 is a diagram of a field feature related to a working event.

FIG. 8 is a diagram showing that an industrial safety feature exists in the field feature.

FIG. 9 is a diagram showing that the industrial safety feature exists in the field feature.

FIG. 10 is a diagram showing that the industrial safety feature exists in the field feature.

FIG. 11 is a diagram showing that the industrial safety feature exists in the field feature.

FIG. 12 is a diagram of setting a default path of the self-propelled device according to the map information.

FIG. 13 is a diagram of the terminal device displaying industrial safety information.

FIG. 14 is a flow chart of the method for monitoring industrial safety.

### DETAILED DESCRIPTION

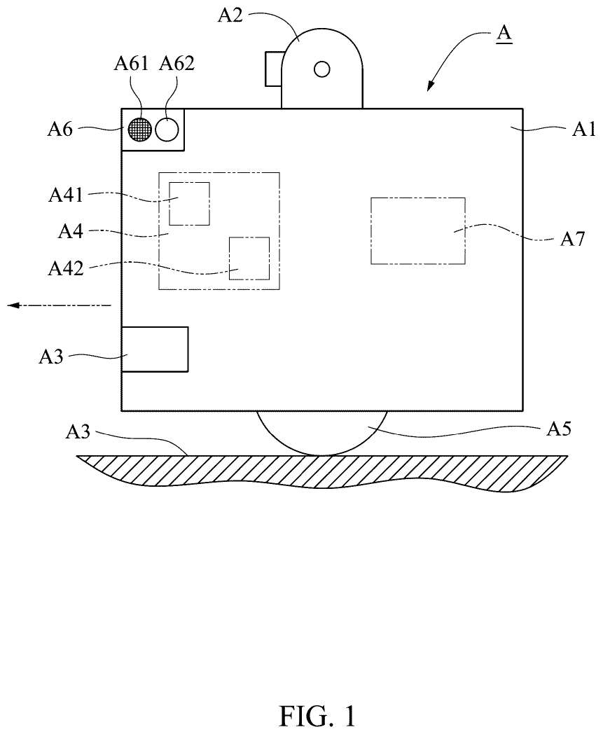

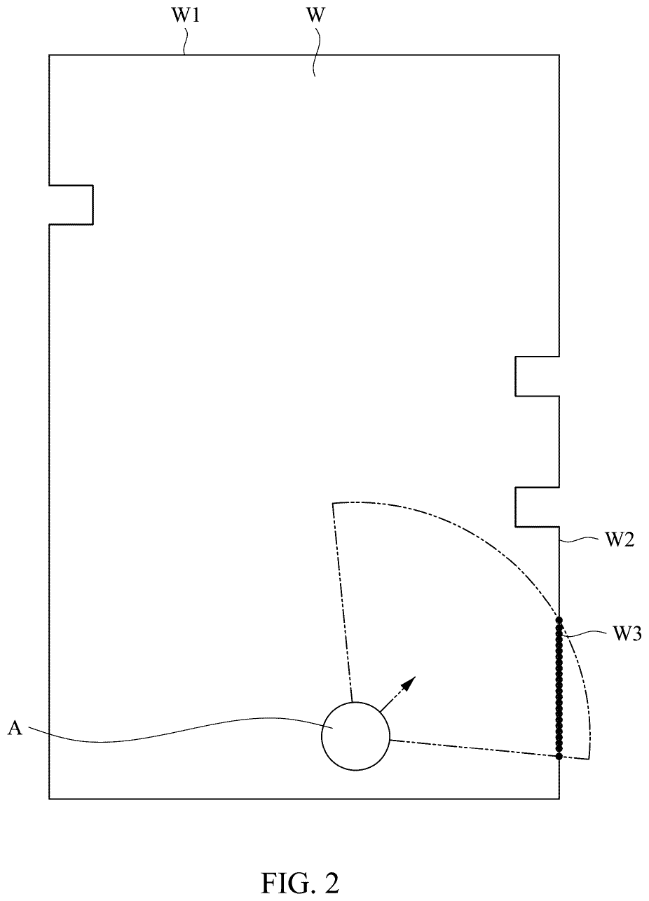

Referring to FIGS. 1 and 2, the embodiment of the invention can be explained by a self-propelled device A as shown in the FIGS. 1 and 2 as an example. The self-propelled device A can move autonomously on a walking surface W1 of a working environment W. The self-propelled device A is arranged on a machine body A1 and is provided with an image capturing unit A2, a detection unit A3, an internal computer A4, a driving unit A5, a warning unit A6 and a control unit A7.

The image capturing unit A2 is disposed on the machine body A1 to capture an environmental image of the working environment W. In one embodiment of the invention, the image capturing unit A2 is a pan-tilt-zoom (PTZ) camera located on an upper side of the machine body A1, in which the lens can rotate horizontally from left to right and vice versa (Pan), and can also be tilted vertically up and down (Tilt) and change focal length (Zoom), but the invention is not limited thereto. The image capturing unit A2 can also be a zoom camera located on a front side of the machine body A1, in which the zoom camera has a fixed capturing direction and angle but has a changeable focal length (Zoom).

The detection unit A3 is disposed on the machine body A1 and has a preset detection direction and a preset detection range (represented by the fan-shaped pattern as shown in FIG. 2). The detection unit A3 can be implemented by one or a combination of common detectors such as a LIDAR (Light Detection and Ranging) sensor, an infrared sensor, and an ultrasonic sensor, etc. The detection unit A3 can be located on the front side of the machine body A1 to detect a structural feature W3 (represented by the dot pattern as shown in FIG. 2) of a physical structure W2 (such as a wall, an obstacle, etc.) in the working environment W.

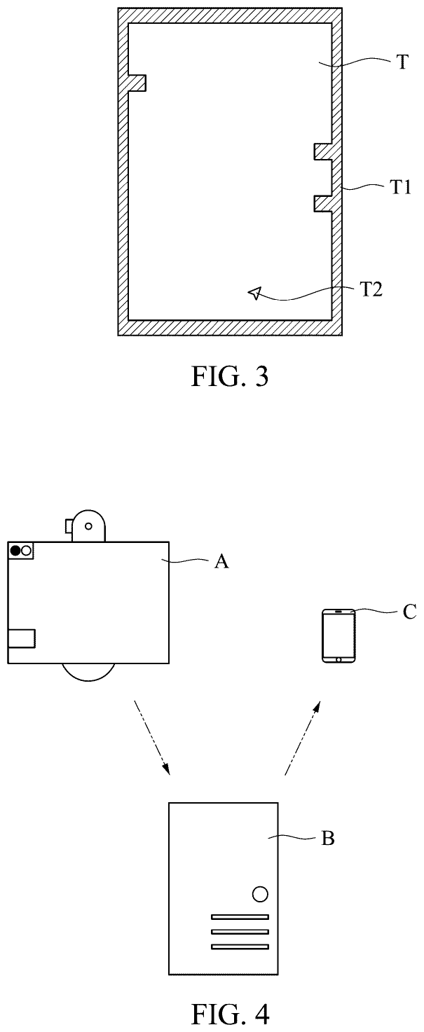

The internal computer A4 has functions such as processing information, storing information, and transmitting information. The environmental image captured by the image capturing unit A2 can be transmitted to a first processing unit A41 of the internal computer A4 for analysis and calculation, and the aforementioned calculation and analysis results are stored in a first memory unit A42 of the internal computer A4. The structural feature W3 detected by the detection unit A3 can also be transmitted to the first processing unit A41 for analysis and calculation, so that the first processing unit A41 can combine the structural feature W3 obtained by the self-propelled device A after traversing the working environment W into a map information T (as shown in FIG. 3) corresponding to the working environment W through an algorithm and store the map information T in the first memory unit A42. The map information T has a map structure T1 (i.e., a line pattern) corresponding to the physical structure W2 and a marking pattern T2 representing a position of the self-propelled device A corresponding to the working environment W. In other words, the map structure T1 corresponds to the physical structure W2 (such as the wall, the obstacle, etc.) in the working environment W. The marking pattern T2 can represent the detection direction of the detection unit A3 of the self-propelled device A (i.e., the forward direction of the self-propelled device A) in an index pattern (i.e., an arrow). In some embodiments, the aforementioned algorithm can be, for example, graph-based simultaneous localization and mapping, so as to use the information (i.e. the shape and the corresponding position of the physical structure A2) obtained by the detection unit A3 to establish the map information T. In this way, the map information T contains the structural features of the corresponding physical structure W2 and the corresponding location information of the corresponding physical structure W2. For example, the wall and/or the obstacle of the working environment W can be scanned by the detection unit A3, thereby obtaining the corresponding shape information and the corresponding position information. Then, the map information T is established by the internal computer A4 based on the information collected by the detection unit A3.

The driving unit A5 is disposed on a lower side of the machine body A1. The driving unit A5 can drive the self-propelled device A to perform movement such as a forward movement, a backward movement, a rotating movement, etc., on the walking surface W1. The warning unit A6 is disposed on the machine body A1. The warning unit A6 is provided with a speaker A61 and a warning light A62. The warning unit A6 can generate a sound by the speaker A61 and generate a light by the warning light A62 as a warning. The control unit A7 can perform relevant control of each functional unit of the self-propelled device A.

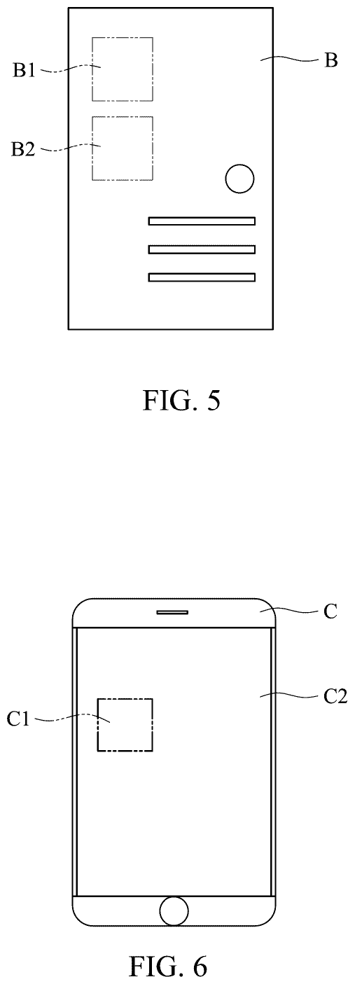

Referring to FIGS. 4, 5 and 6, the self-propelled device A can form a system for monitoring industrial safety with an external computer B and a terminal device C. The method for monitoring industrial safety of the embodiment of the invention can be realized by using the system for monitoring industrial safety.

The external computer B has functions such as processing information, storing information, and transmitting information, etc. The self-propelled device A can output the industrial safety information to the external computer B. A second processing unit B1 of the external computer B processed the industrial safety information into a format that is easy for the industrial safety personnel to interpret, and then stored the industrial safety information with the appropriate format to a second memory unit B2 of the external computer B, or wirelessly transmitted the industrial safety information with the appropriate format to the terminal device C directly. The external computer B can be but is not limited to, for example, an enterprise-owned server or one of the common cloud servers such as Amazon Web Services (AWS) cloud server, IBM (International Business Machines Corporation) cloud server, Google cloud server, Microsoft Azure cloud server, Alibaba cloud server, etc.

The terminal device C is provided with a third processing unit C1 and a display device C2. The terminal device C can receive the industrial safety information transmitted from the external computer B. Then, the third processing unit C1 processes the industrial safety information into the format that is easy for the industrial safety personnel to interpret. The industrial safety information with the appropriate format is displayed by the display device C2. The terminal device C can be but is not limited to, for example, one of the common terminal devices such as a smart phone, a smart tablet, a notebook computer, a personal computer, etc.

In another embodiment of the invention, the operator responsible for operating the self-propelled device A sets a field feature related to a working event and an industrial safety feature related to an industrial safety event of the first processing unit A41 of the internal computer A4 by using a decision method such as machine learning, artificial intelligence, etc. Then, a default path of the self-propelled device A is set according to the map information T.

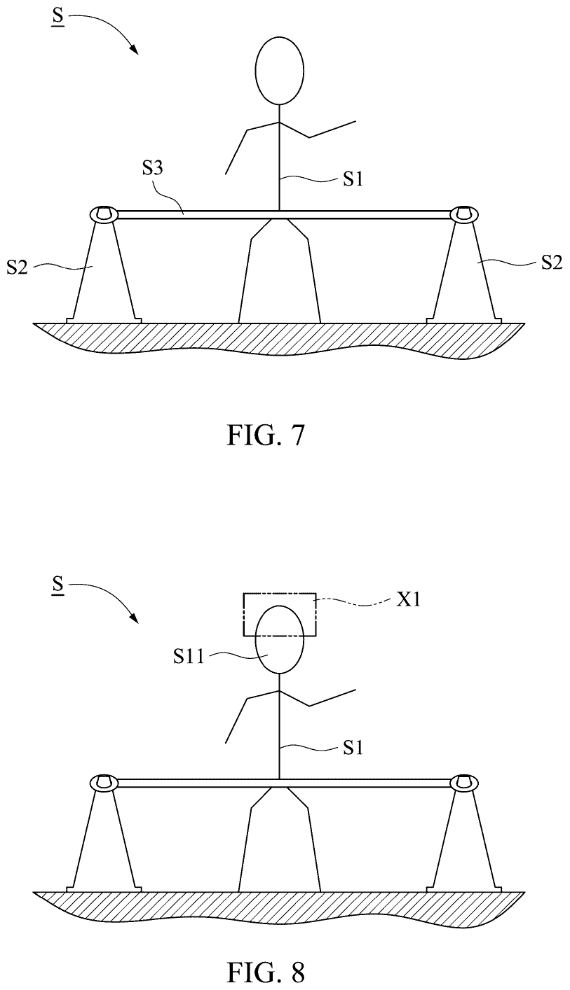

The field feature S (as shown in FIG. 7) can be, for example, that there is at least one humanoid object S1 and two traffic cones S2 in the working environment W, and the humanoid object S1 is between two traffic cones S2 spaced apart. In order to make the field feature S easier to discover, the field feature S can also add that there is a cross rod S3 arranged across the traffic cones S2 in the working environment W and the humanoid object S1 is located on a side of the cross rod S3 away from the self-propelled device A (that is, the cross rod S3 is located between the humanoid position S1 and the self-propelled device A).

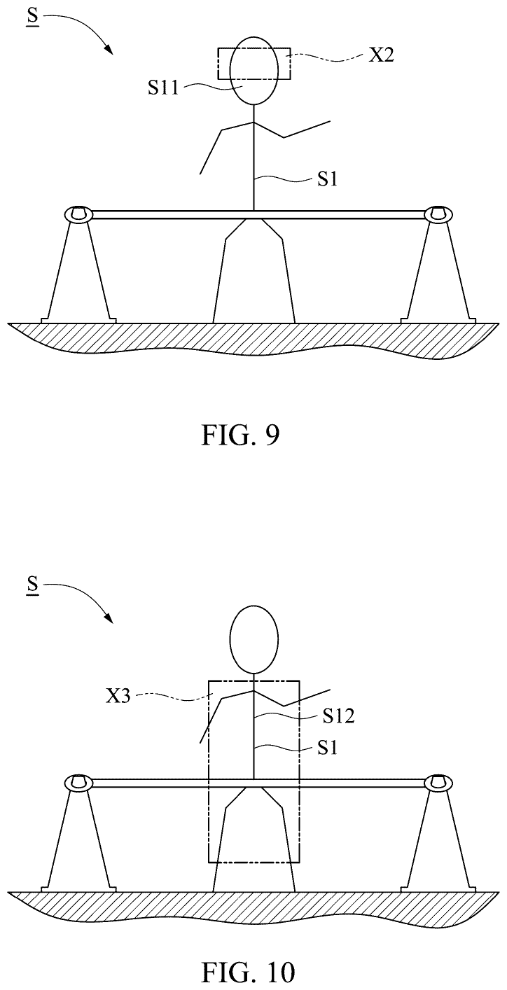

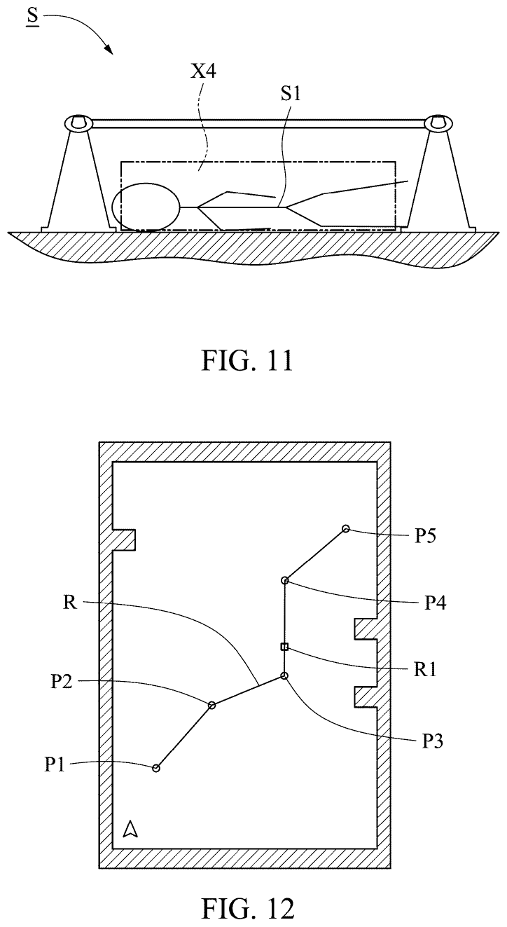

There may be different industrial safety events in the field feature S, and there may also be different industrial safety features Xn (n is a natural number greater than or equal to 1) in the field feature S. For example, there is an industrial safety feature X1 in the field feature S that the head S11 of the humanoid object S1 is not wearing a safety helmet (as shown in FIG. 8). For example, there is an industrial safety feature X2 in the field feature S that the head S11 of humanoid object S1 is not wearing goggles (as shown in FIG. 9). For example, there is an industrial safety feature X3 in the field feature S that the body S12 of the humanoid object S1 is not wearing protective clothing (as shown in FIG. 10). For example, there is an industrial safety feature X4 in the field feature S that the humanoid object S1 has fallen down (as shown in FIG. 11). Therefore, the operator can set at least one industrial safety feature Xn according to actual needs.

The preset path R (as shown in FIG. 12) is provided with plural nodes Pn (n is a natural number greater than or equal to 1) for the self-propelled device A to pass by in a preset order. The preset order may be, for example, the node P1, and then the node P2, and then the node P3, and then the node P4, and then the node P5.

After setting the field feature S, the industrial safety feature Xn, and the preset path R, when the industrial safety monitoring begins, the self-propelled device A leaves the docking station such as the charging station, such that the self-propelled device A refers to the map information T corresponding to the working environment W and moves in the working environment W according to the preset path R. Meanwhile, the image capturing unit A2 captures an environmental image of the working environment W, such that the first processing unit A41 of the internal computer A4 analyzes the environmental image.

When the environmental image is analyzed and it was determined that there is no field feature S in the working environment W (that is, no working event is found), the first processing unit A41 of the internal computer A4 of the self-propelled device A determines whether the preset path R has been completed. If the preset path R has not been completed, the self-propelled device A continues to move along the preset path R. If the preset path R has been completed, the self-propelled device A ends the work safety monitoring and returns to the docking station, such as the charging station.

When the environmental image is analyzed and it was determined that there is a field feature S in the working environment W (that is, a work event is discovered), the self-propelled device A stays at the location where the field feature S is captured. For example, the self-propelled device A stays at a stay point R1 on the preset path R between the nodes P3 and P4. The self-propelled device A stays on the preset path R and will not leave the preset path R.

During the self-propelled device A stays, the image capturing unit A2 continues to capture the environmental image for detecting the field feature S, such that the first processing unit A41 of the internal computer A4 analyzes the environmental image. The image capturing unit A2 can capture the field feature S with various angles (such as capturing the top, bottom, left, and right of the field feature S) or various focal lengths (such as zooming in or out).

When the environmental image is analyzed that there is no industrial safety feature Xn in the field feature S (that is, no industrial safety event occurs), the first processing unit A41 of the internal computer A4 of the self-propelled device A determines whether the stay time of the self-propelled device A has reached the preset time such as 10 minutes (that is the self-propelled device A has stayed for 10 minutes). If the stay time of the self-propelled device A has not reached the preset time, the self-propelled device A continues to stay and continues to capture the environmental image through the image capturing unit A2. If the stay time of the self-propelled device A has reached the preset time, the self-propelled device A leaves the stay point R1 and continues to move along the preset path R.

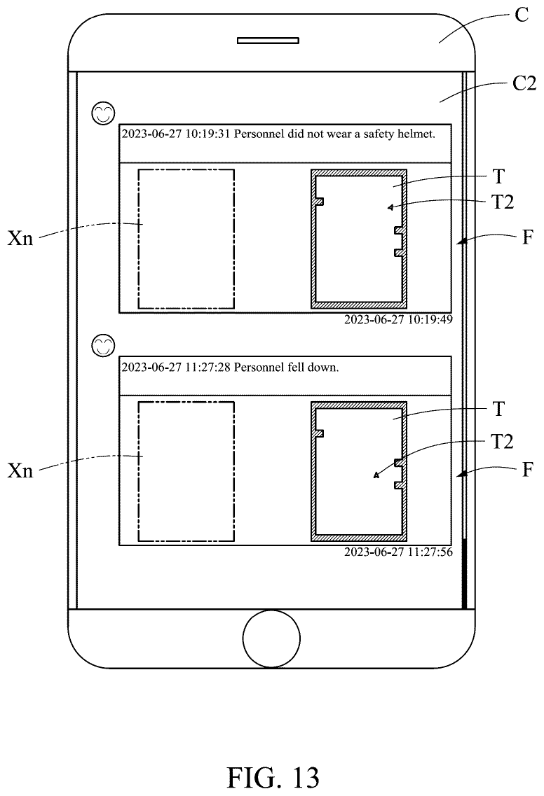

When the environmental image is analyzed that there is an industrial safety feature Xn in the field feature S (that is, an industrial safety event occurs), the internal computer A4 of the self-propelled device A transmits industrial safety information related to the industrial safety event to the terminal device C, and the industrial safety information is displayed on the display device C2, so that industrial safety personnel can realize the on-site situation remotely. At this time, the warning unit A6 of the self-propelled device A can also generate sound and light as a warning to remind workers involved in the industrial safety event. As shown in FIG. 13, the industrial safety information F displayed on the display device C2 may include text or image indicating a time point, a type, and a position that the industrial safety event occurs. For example, the text may be “2023-06-27 10:19:31 Personnel did not wear a safety helmet” or “2023-06-27 11:27:28 Personnel fell down”. For example, the image may be utilized to represent the map information T. For example, the image may be utilized to represent the marking pattern T2 and the industrial safety feature Xn of the self-propelled device A at the corresponding position in the working environment W. The sound generated by the warning unit A6 may be voice of the text.

After the self-propelled device A transmits the industrial safety information F, the first processing unit A41 of the internal computer A4 of the self-propelled device A continues to determine whether the stay time of the self-propelled device A has reached the preset time. If the stay time of the self-propelled device A has not reached the preset time, the self-propelled device A continues to stay and continues to capture the environmental images through the image capturing unit A2. If the stay time of the self-propelled device A has reached the preset time, the self-propelled device A leaves the stay point R1 and continues to move along the preset path R.

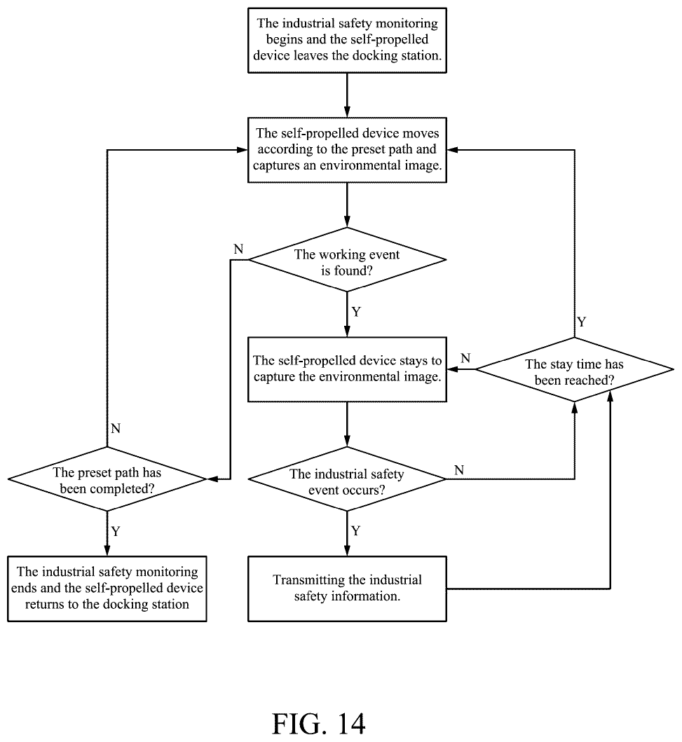

The aforementioned flow of the industrial safety monitoring process is depicted in a flow chart as shown in FIG. 14.

According to the method and the system for monitoring industrial safety and the self-propelled device of the embodiment of the invention, the self-propelled device A can capture an environmental image of the working environment W and analyze the environmental image. When the environmental image is analyzed that the working event occurs, the self-propelled device A stays at a location where the working event occurs and monitors whether the industrial safety event occurs. When the industrial safety event occurs, the self-propelled device A transmits the industrial safety information F related to the industrial safety event to the terminal device C, thereby helping the industrial safety personnel located remotely to be timely informed of the on-site situation.

However, the descriptions as mentioned above are only preferred embodiments of the invention, and should not limit the scope of implementation of the invention. That is, any simple equivalent changes and modifications made according to and/or consistent with the scope of the claim and the contents of the description of the invention are still within the scope of the claim of the invention.

What is claimed is:

1. A method for monitoring industrial safety, comprising:
providing a self-propelled device having an image capturing unit and an internal computer;
providing a terminal device having a display device;
setting a field feature related to a working event and an industrial safety feature related to an industrial safety event;
controlling the self-propelled device to move within a working environment, while controlling the image capturing unit to capture an environmental image of the working environment, and further controlling the internal computer to analyze the environmental image;
controlling the self-propelled device to stay at a location where the field feature is captured when it is determined that the analyzed environmental image indicates presence of the field feature in the working environment;
controlling the image capturing unit to continue to capture additional environmental images with the field feature and controlling the internal computer to continue to analyze the environmental images during the self-propelled device stays; and
controlling the self-propelled device to transmit an industrial safety information related to the industrial safety event to the terminal device and display the industrial safety information on the display device when it is determined that the analyzed environmental image contains the industrial safety feature in the field feature.

2. The method of claim 1, wherein the field feature comprises a humanoid object between two traffic cones spaced apart in the working environment.

3. The method of claim 2, wherein the field feature further comprises a cross rod arranged across the traffic cones, and the humanoid object is located on a side of the cross rod away from the self-propelled device.

4. The method of claim 1, wherein the image capturing unit is a pan-tilt-zoom (PTZ) camera, wherein during the self-propelled device stays, the image capturing unit captures the field feature from various angles.

5. The method of claim 1, wherein the image capturing unit is a camera that a lens can be controlled to change focal length, wherein during the self-propelled device stays, the image capturing unit captures the field feature using various focal lengths.

6. The method of claim 1, wherein the self-propelled device refers to a map information corresponding to the working environment, wherein the self-propelled device moves within the working environment according to a preset path, wherein the preset path is provided with a plurality of nodes for the self-propelled device to pass through in a preset order.

7. The method of claim 6, wherein the location that the self-propelled device stays is on the preset path.

8. The method of claim 6, wherein when the time which the self-propelled device stays at the location where it captured the field feature reaches a preset time, the self-propelled device continues to move within the working environment according to the preset path.

9. The method of claim 1, wherein the self-propelled device is provided with a warning unit, wherein when the environmental image is analyzed and it is determined that the industrial safety feature is present in the field feature, the warning unit generates sound and light as a warning.

10. The method of claim 1, wherein the industrial safety information displayed on the display device corresponds to a time point, a type, and a position that the industrial safety event occurs.

11. A system for monitoring industrial safety configured to perform the method of claim 1.

12. A system for monitoring industrial safety configured to perform the method of claim 2.

13. A system for monitoring industrial safety configured to perform the method of claim 3.

14. A system for monitoring industrial safety configured to perform the method of claim 4.

15. A system for monitoring industrial safety configured to perform the method of claim 5.

16. A self-propelled device configured to perform the method of claim 1.

17. A self-propelled device configured to perform the method of claim 2.

18. A self-propelled device configured to perform the method of claim 3.

19. A self-propelled device configured to perform the method of claim 4.

20. A self-propelled device configured to perform the method of claim 5.
